(19) United States
(12) Patent Application Publication
(10) Pub. No.: US 2023/0311352 A1
(43) Pub. Date: Oct. 5, 2023

(54) RAZOR BLADE

(71) Applicant: DORCO CO., LTD., Gyeonggi-do (KR)

(72) Inventors: Hyun Ju LEE, Seoul (KR); Kwang Choon RYU, Seoul (KR); Myoung Jin KIM, Seoul (KR)

(73) Assignee: DORCO CO., LTD., Gyeonggi-do (KR)

(21) Appl. No.: 18/002,243

(22) PCT Filed: May 28, 2021
(86) PCT No.: PCT/KR2021/006686

§ 371 Date: Dec. 16, 2022

(30) Foreign Application Priority Data
Jun. 16, 2020 (KR) 10-2020-0073111

(51) Int. Cl. B26B 21/56; B26B 21/40

(52) U.S. Cl. CPC B26B 21/56; B26B 21/4031

(57) ABSTRACT

A shaving blade is disclosed herein. An embodiment of the present disclosure provides a shaving blade including: a substrate including a cutting edge at which a sharp substrate tip is formed, wherein the substrate has a thickness T10 measured at a distance D10 that is 10 micrometers away from the substrate tip, the thickness T10 having a value between 3.18 micrometers and 3.66 micrometers, and a thickness T100 measured at a distance D100 that is 100 micrometers away from the substrate tip, the thickness T100 having a value between 14.82 micrometers and 18.85 micrometers.

### FIELD OF THE PRESENT DISCLOSURE

The present disclosure relates to shaving blade.

### DESCRIPTION OF RELATED ART

The content described in this paragraph merely provides background information for the present disclosure and does not constitute the prior art.

A shape of a shaving blade plays an important role in the quality of shaving. In particular, a shape of a cutting edge included in a substrate of the shaving blade has a great influence on a cutting force of the shaving blade. Here, the cutting force refers to a force required for a shaving blade to cut one body hair.

As the cutting force of the shaving blade decreases, the body hair can be cut using a smaller force, so that a user can experience a smoother feeling of shaving.

In general, a cutting force of a shaving blade decreases as a thickness of the cutting edge decreases. However, the cutting edge needs to have a thickness equal to or greater than a certain value for durability of the shaving blade.

Therefore, it is not possible to design the thickness of the cutting edge to be infinitely small in order to reduce the cutting force, and a design of a profile of the cutting edge capable of sufficiently reducing the cutting force of the shaving blade, even when the thickness of the cutting edge is reduced by a relatively small amount, is required.

In a shaving blade of the related art, attention is paid to an area very close to a substrate tip in a cutting edge in order to reduce a cutting force of the shaving blade, and focus is made on optimization of a thickness of the cutting edge in such an area.

Meanwhile, a shaving blade design of the related art simply focuses on an overall thickness of the cutting edge, and a correlation between a thickness in each area of the cutting edge and the durability of the shaving blade and a correlation between the thickness in each area of the cutting edge and the cutting force of the shaving blade have not been sufficiently considered.

### BRIEF SUMMARY

Therefore, a main object of the present disclosure is to study a correlation between a thickness in each area of a cutting edge and durability or a cutting force of a shaving blade, find an area in which change in thickness of the shaving blade has the greatest influence on increase in durability and decrease in cutting force, and optimize the thickness of the shaving blade in each area having the greatest influence on the increase in durability and the decrease in cutting force, thereby improving the durability of the shaving blade and reducing the cutting force of the shaving blade.

An embodiment of the present disclosure provides a shaving blade including: a substrate including a cutting edge at which a sharp substrate tip is formed, wherein the substrate has a thickness T10 measured at a distance D10 that is 10 micrometers away from the substrate tip, the thickness T10 having a value between 3.18 micrometers and 3.66 micrometers, and a thickness T100 measured at a distance D100 that is 100 micrometers away from the substrate tip, the thickness T100 having a value between 14.82 micrometers and 18.85 micrometers.

As described above, according to the present embodiment, with the shaving blade, it is possible to realize improvement of durability and reduction in a cutting force at the same time.

### BRIEF DESCRIPTION OF THE DRAWINGS

FIG. 1 illustrates a schematic profile of a cutting edge of a substrate according to an embodiment of the present disclosure;

FIG. 2 illustrates a schematic profile of an area near a tip of the substrate at the cutting edge of FIG. 1.

FIG. 3 is a graph illustrating a distribution of sizes of defects occurring at the cutting edge.

FIG. 4 is an enlarged view of the cutting edge at which defects have occurred.

FIG. 5 illustrates a schematic profile of a cutting edge of a substrate on which a plurality of coating layers are stacked according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary.

As used herein, DX refers to a point on a cutting edge X micrometers away from a substrate tip of a shaving blade. Furthermore, TX refers to a thickness value of the cutting edge at the point DX. For example, T16 means a thickness value of the cutting edge at D16 that is 16 micrometers away from the substrate tip of the shaving blade.

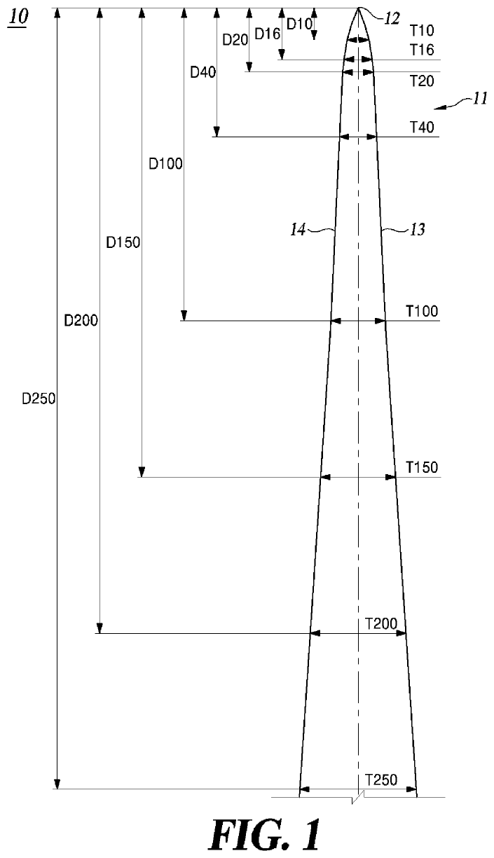

FIG. 1 illustrates a schematic profile of a cutting edge 11 of a substrate 10 according to an embodiment of the present disclosure.

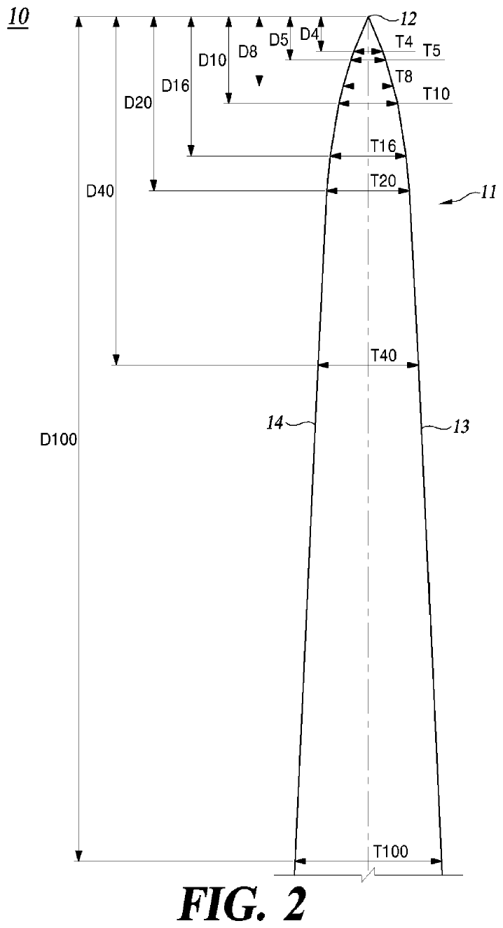

FIG. 2 illustrates a schematic profile of an area near a substrate tip 12 of the cutting edge 11 of FIG. 1.

Referring to FIGS. 1 and 2, a shaving blade may include the substrate 10 having the cutting edge 11 at which the sharp substrate tip 12 is formed.

Both side surfaces 13 and 14 of the cutting edge 11 may have an inclined shape and converge toward the substrate tip 12 formed at one end of the cutting edge 11.

The substrate 10 may be made of any one of stainless steel, carbon steel, and ceramic, but the present disclosure is not limited thereto.

Both the side surfaces 13 and 14 of the cutting edge 11 may comprise a plurality of facets formed by an abrading wheel.

The facet may include a first facet spaced apart from the substrate tip 12 and a second facet extending from the substrate tip 12. In this case, the second facet may non-uniformly overlap with at least a portion of the first facet.

The first facet may be formed by an abrading wheel made of cubic boron nitride (CBN) having relatively coarse and sparse grains. Furthermore, the second facet may be formed by an abrading wheel having relatively fine and dense grains.

The facet may be formed uniformly on the substrate 10 from the substrate tip 12 to 300 to 500 micrometers.

The shaving blade according to an embodiment of the present disclosure is technically characterized in that not only the cutting force of the shaving blade but also the durability of the shaving blade is effectively improved by optimizing a thickness of the cutting edge 11 in a section from D0 to D10 highly correlated with the durability of the shaving blade and a section from D10 to D100 highly correlated with the cutting force of the shaving blade. Details related thereto will be described hereinafter.

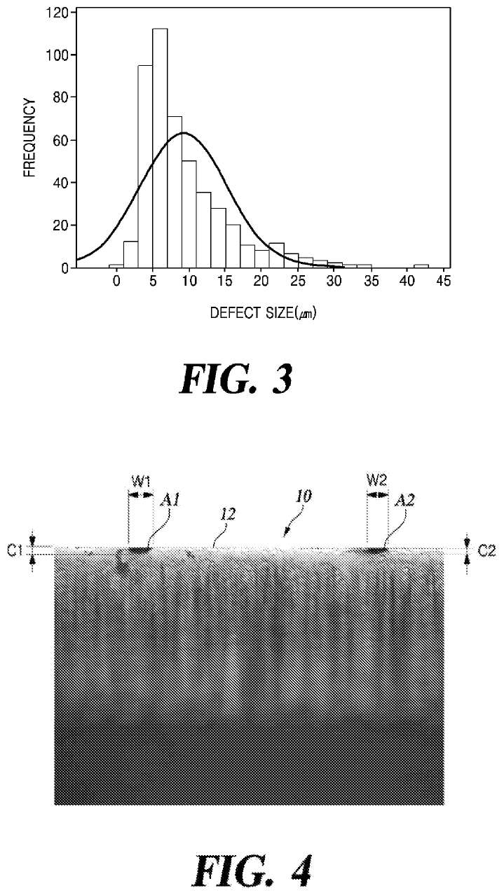

FIG. 3 is a graph illustrating a distribution of sizes of defects occurring at the cutting edge 11.

FIG. 4 is an enlarged view of the cutting edge 11 at which defects have occurred.

Specifically, the graph of FIG. 3 shows results of a panel of 150 people performing a home use test (HUT) for two months with shaving blades having various thicknesses mounted on the same cartridge. In this experiment, each user performed seven full shavings on each product, and about 1000 cuttings were performed on average on one point of the shaving blade in the seven full shavings.

Referring to the graph of FIG. 3, it can be seen that defects having a size of 10 micrometers or less have a relatively high frequency among all the defects. Here, the defect refers to an area from the substrate tip 12 fractured at the time of shaving, and the size of the defect refers to a depth from the substrate tip 12 of the fractured area.

Referring to FIG. 4, an enlarged photograph of an exemplary cutting edge 11 at which two defects A1 and A2 have been created on the substrate tip 12 is illustrated.

The defects of the cutting edge are formed to have a predetermined width WX and a predetermined depth CX at the substrate tip 12. For example, the two defects A1 and A2 according to the example of FIG. 4 have widths of W1 (=39.895 micrometers) and W2 (=33.927 micrometers) and depths of C1 (=9.738 micrometers) and C2 (=9.424 micrometers), respectively. In this case, sizes of the two defects A1 and A2 are 9.738 micrometers and 9.424 micrometers, which are values corresponding to C1 and C2, respectively.

On the other hand, the size of the defect has an influence on the durability of the shaving blade. Therefore, the high frequency of the defects having a size of 10 micrometers or less means that a section of the cutting edge 11 highly correlated with the durability of the shaving blade is a section from the substrate tip 12 to D10.

From this point of view, the shaving blade according to the embodiment of the present disclosure is technically characterized in that the durability of the shaving blade is improved by relatively increasing a thickness in a section from the substrate tip 12 to D10, which is highly correlated with durability.

TABLE 1

| | | | | | | | | | edge indent |
|---|---|---|---|---|---|---|---|---|---|
| | | | | | | | | | force |
| | | | | | | | | cutting | resistance |
| | T4 | T10 | T16 | T40 | T64 | T100 | T150 | force | at T10 |
| Comparative | 2.04 | 4.06 | 6.34 | 15.12 | 24.13 | 30.73 | 44.12 | 5.97 | 24.86 |
| example 1 | | | | | | | | | |
| Comparative | 1.96 | 3.93 | 5.94 | 14.45 | 19.37 | 28.83 | 42.75 | 5.75 | 24.78 |
| example 2 | | | | | | | | | |
| Comparative | 1.69 | 3.86 | 5.56 | 11.65 | 18.64 | 27.56 | 41.60 | 5.57 | 24.54 |
| example 3 | | | | | | | | | |
| Comparative | 1.67 | 3.73 | 5.41 | 13.05 | 18.04 | 27.91 | 43.12 | 5.40 | 22.64 |
| example 4 | | | | | | | | | |
| Comparative | 1.65 | 3.67 | 5.26 | 11.09 | 14.94 | 27.21 | 42.10 | 5.38 | 22.59 |
| example 5 | | | | | | | | | |
| Comparative | 1.83 | 3.45 | 4.97 | 10.91 | 14.67 | 23.22 | 33.50 | 5.20 | 21.52 |
| example 6 | | | | | | | | | |
| Comparative | 1.72 | 3.09 | 4.14 | 6.91 | 9.81 | 11.69 | 14.54 | 4.55 | 18.13 |
| example 7 | | | | | | | | | |

Table 1 shows a thickness of a cutting edge along a distance from a substrate tip, a cutting force, and an edge indent force resistance at T10 in a plurality of comparative examples. Specifically, among the plurality of comparative examples, comparative examples 1 to 4 correspond to shaving blades used in actual razor products, and comparative examples 5 to 7 correspond to shaving blades separately manufactured for an experiment.

In Table 1, the unit of the thickness of the cutting edge is and the unit of the cutting force and the edge indent force resistance is gf.

The thickness of the cutting edge 11 shown in Table 1 is measured using a scanning electron microscope (SEM). However, the present disclosure is not limited thereto, and the thickness of the cutting edge 11 may be measured using an interferometer or a confocal microscope.

On the other hand, the edge indent force resistance refers to resistance generated when an indenter tip having a triangular prism shape is transported toward the cutting edge 11 in a state, for example, in which the indenter tip is brought into vertical contact with an area of the cutting edge 11 in a section having T10 or less. This edge indent force resistance can be utilized as a measure of the durability of the shaving blade.

Using thickness distribution data of the cutting edge of each comparative example and cutting force data of each comparative example shown in Table 1, a regression equation of Equation 1 below can be obtained. Equation 1 may approximately show a relationship between the cutting force of the shaving blade and the thickness distribution of the cutting edge.

Cutting force=1.97+0.446×T10+0.174×T16+0.011×T40+0.014×T64+0.017×T100 [Equation 1]

Meanwhile, the data for the plurality of comparative examples shown in Table 1 are derived by using actually manufactured specimens, and some of the plurality of comparative examples are actually used in razor products. In this aspect, Equation 1 has high reliability, and a result from Equation 1, which will be described below, can also have high reliability.

When a correlation between the thickness in each area of the cutting edge and the cutting force of the cutting edge is obtained using Equation 1, a result of Table 2 below can be obtained.

TABLE 2

| Thickness | T4 | T10 | T16 | T40 | T64 | T100 | T150 |
|---|---|---|---|---|---|---|---|
| Correlation | 0.390 | 0.944 | 0.983 | 0.969 | 0.964 | 0.956 | 0.938 |

The correlation in Table 2 is a numerical representation of a degree of correlation between change in thickness and change in cutting force in each area. Therefore, when a correlation of a certain thickness area is low, a degree of change in cutting force may be relatively small even when the thickness of the area having the low correlation changes as compared with the thickness of other areas having a higher correlation.

For example, in Table 2, the correlation of T10 is 0.944, which is greater than 0.390 that is the correlation of T4. Thus, the reduction in thickness required to reduce the same magnitude of cutting force may be smaller at T10 than at T4. That is, when the thickness of the shaving blade reduced at T10 is equal to the thickness of the shaving blade reduced at T4, an effect of reduction in the cutting force that can be obtained at T10 is greater than an effect that can be obtained at T4.

Referring to Table 2, the correlation is highest at T16, and gradually decreases in an order of T40, T64, and T100, which are the thicknesses at D16 or more away from the substrate tip 12. On the other hand, the correlation of T10 rather than T150 has the greatest value next to the correlation of T100. That is, it can be seen that the correlation decreases relatively significantly starting from T100. This means that a section of the cutting edge highly correlated with the cutting force of the shaving blade is the section from D10 to D100.

In this regard, the shaving blade according to the embodiment of the present disclosure is technically characterized in that the cutting force of the shaving blade is reduced by relatively decreasing the thickness in the section from D10 to D100 highly correlated with the cutting force.

For improvement of the durability and reduction in the cutting force, a design of the shaving blade of the related art is focused on an entire area of the cutting edge and is mainly focused on optimization of the thickness of the entire area of the cutting edge, whereas the applicant found from the above-described experimental data that the section from the substrate tip 12 to D10 was highly correlated with the durability of the shaving blade, and the section from D10 to D100 was highly correlated with the cutting force of the shaving blade.

Accordingly, the applicant conducted a study on the thickness of the cutting edge 11 in the section from the substrate tip 12 to D10 and the section from D10 to D100. Hereinafter, details of the shaving blade according to the embodiment of the present disclosure derived on the basis of such a study will be described.

First, the applicant measured a size of a defect in a plurality of embodiments shown in Table 1 in order to measure a magnitude of durability of a preferable shaving blade. As a result, only defects having a size of about 8 micrometers occurred in Comparative examples 1 to 6, but a defect having a size of about 15 micrometers or more occurred in Comparative example 7.

Furthermore, the applicant performed cutting simulation by repeatedly stroking one body hair (or a wire having a similar shape or property) with a single shaving blade in the plurality of embodiments shown in Table 1. As a result, no miss cut occurred even after about 300 strokes in Comparative examples 1 to 6, whereas a miss cut occurred after about 50 strokes in Comparative example 7. Here, the miss cut refers to a case in which the hair is not cut by the shaving blade even though the hair is stroked.

Referring to Table 1, the edge indent force resistance is 20 gf or more in Comparative examples 1 to 6, and the edge indent force resistance is less than 20 gf in Comparative example 7. This means that the shaving blade should have the edge indent force resistance of at least 20 gf for satisfactory shaving. Therefore, it is preferable for the shaving blade to have the edge indent force resistance of 20 gf or more.

Furthermore, the applicant conducted a survey on feeling of use of the shaving blades for the plurality of embodiments shown in Table 1 in order to measure a preferable magnitude of the cutting force. In this experiment, a user performed shaving using the shaving blade in Comparative example 1 and then performed shaving using the shaving blades in the other comparative examples. As a result, the user did not experience improvement in the feeling of use from Comparative examples 2 and 3 as compared with Comparative example 1, and experienced improvement in the feeling of use in Comparative example 4 and the subsequent examples.

Referring to Table 1, the cutting force in Comparative example 1 is 5.97 gf, and the cutting force in Comparative example 3 is 5.57 gf. Therefore, a difference between the cutting force in Comparative example 1 and the cutting force in Comparative example 3 is 0.40 gf. That is, in order to experience improved feeling of use from a certain shaving blade with respect to another shaving blade, it may be necessary to reduce the cutting force of the certain shaving blade by at least more than 0.40 gf as compared with the cutting force of the other shaving blade.

Meanwhile, among the plurality of comparative examples, comparative Examples 1 to 4 correspond to shaving blades used in actual products, and Comparative example 4 has the smallest cutting force. Therefore, in order to experience improved feeling of use as compared with shaving blades of the related art (that is, the shaving blades used in actual products), it is necessary to reduce the cutting force of the shaving blade by at least more than 0.40 gf as compared with the cutting force in Comparative example 4. That is, the shaving blade needs to have a cutting force of less than 5.00 gf.

As a result, considering a relationship between the thickness, durability, and the cutting force in each area of the cutting edge 11, a magnitude of preferable durability, and a magnitude of a preferable cutting force, the thickness of the substrate 10 along the distance from the substrate tip 12 in the substrate 10 according to the embodiment of the present disclosure may have a value in a range shown in Table 3 below.

TABLE 3

| Thickness | Value (unit: μm) |
|---|---|
| T4 | 1.43 to 1.99 |
| T5 | 1.89 to 2.51 |
| T8 | 2.80 to 3.30 |
| T10 | 3.18 to 3.66 |
| T16 | 4.32 to 4.90 |
| T20 | 5.05 to 5.64 |
| T40 | 7.20 to 8.89 |
| T100 | 14.82 to 18.85 |
| T150 | 20.05 to 26.25 |
| T200 | 28.82 to 34.02 |
| T250 | 38.98 to 44.27 |

Referring to Table 3, a thickness T10 measured at a distance D10 that is 10 micrometers away from the substrate tip 12 may have a value between 3.18 micrometers and 3.66 micrometers, and a thickness T100 measured at the distance D100 that is 100 micrometers away from the substrate tip 12 may have a value between 14.82 micrometers and 18.85 micrometers.

A thickness T4 measured at a distance D4 that is 4 micrometers away from the substrate tip 12 may have a value between 1.43 and 1.99 micrometers.

A thickness T5 measured at a distance D5 that is 5 micrometers away from the substrate tip 12 may have a value between 1.89 and 2.51 micrometers.

A thickness T8 measured at a distance D8 that is 8 micrometers away from the substrate tip 12 may have a value between 2.80 micrometers and 3.30 micrometers.

A thickness T16 measured at a distance D16 that is 16 micrometers away from the substrate tip 12 may have a value between 4.32 and 4.90 micrometers.

A thickness T20 measured at a distance D20 that is 20 micrometers away from the substrate tip 12 may have a value between 5.05 and 5.64 micrometers.

A thickness T40 measured at a distance D40 that is 40 micrometers away from the substrate tip 12 may have a value between 7.20 micrometers and 8.89 micrometers.

A thickness T150 measured at a distance D150 that is 150 micrometers away from the substrate tip 12 may have a value between 20.05 micrometers and 26.25 micrometers.

A thickness T200 measured at a distance D200 that is 200 micrometers away from the substrate tip 12 may have a value between 28.82 and 34.02 micrometers.

A thickness T250 measured at a distance D250 that is 250 micrometers away from the substrate tip 12 may have a value between 38.98 and 44.27 micrometers.

Referring to the thickness of the shaving blade according to the embodiment of the present disclosure described above, a thickness of the cutting edge 11 in a section from the substrate tip 12 to D10, which is highly correlated with the durability of the shaving blade, may have a value substantially greater than that of the shaving blade of the related art, and a thickness of the cutting edge 11 in the section from D10 to D100, which is highly correlated with the cutting force of the shaving blade, may have a substantially smaller value than that of the shaving blade of the related art.

Referring back to Table 3, R8 obtained by dividing the thickness T8 measured at the distance D8 that is 8 micrometers away from the substrate tip 12 by D8 may have a value equal to or greater than R10 obtained by dividing the thickness T10 measured at the distance D10 that is 10 micrometers away from the substrate tip 12 by D10.

Furthermore, R16 obtained by dividing the thickness T16 measured at the distance D16 that is 16 micrometers away from the substrate tip 12 by D16 may have a value equal to or less than R10 obtained by dividing the thickness T10 measured at the distance D10 that is 10 micrometers away from the substrate tip 12 by D10.

RX, by definition, may be proportional to an average slope of both the side surfaces 13 and 14 of the cutting edge 11 in an area from the substrate tip 12 to DX. For example, R8 being greater than R10 means that an average slope of the cutting edge 11 from the substrate tip 12 to D8 is greater than an average slope of the cutting edge 11 from the substrate tip 12 to D10.

Therefore, since R10 is a value less than R8 and greater than R16, and D10 and D8, and D10 and D16 are each sufficiently similar distances, the cutting edge 11 may have a substantially convex shape in an area around D10. This convex shape of the substrate 10 has an effect of improving the durability and physical properties of the shaving blade.

Furthermore, R100 obtained by dividing the thickness T100 measured at the distance D100 that is 100 micrometers away from the substrate tip 12 by D100 may have a value equal to or less than R10 obtained by dividing the thickness T10 measured at the distance D10 that is 10 micrometers away from the substrate tip 12 by D10.

Meanwhile, a difference between the thickness T10 measured at the distance D10 that is 10 micrometers away from the substrate tip 12 and the thickness T8 measured at the distance D8 that is 8 micrometers away from the substrate tip 12 may have a value of 0.86 micrometers or less.

A difference between TX and TY may be proportional to the average slope of both the side surfaces 13 and 14 of the cutting edge 11 in an area from DX to DY.

Therefore, a large difference between TX and TY means that a slope of both the side surfaces 13 and 14 of the cutting edge 11 is steep in the area from DX to DY, and conversely, a small difference between TX and TY means that the slope of both the side surfaces 13 and 14 of the cutting edge 11 is gentle in the area from DX to DY.

Since the shaving blade according to the embodiment of the present disclosure has a relatively large thickness in an area from the substrate tip 12 to D10, the cutting edge 11 may have a relatively steep slope in an area from D8 to D10.

Furthermore, a difference between the thickness T100 measured at the distance D100 that is 100 micrometers away from the substrate tip 12 and the thickness T40 measured at a distance D40 that is 40 micrometers away from the substrate tip 12 may have a value of 11.65 micrometers or less.

Furthermore, a difference between the thickness T150 measured at a distance D150 that is 150 micrometers away from the substrate tip 12 and the thickness T100 measured at the distance D100 that is 100 micrometers away from the substrate tip 12 may have a value of 11.43 micrometers or more.

The shaving blade according to the embodiment of the present disclosure has a relatively small thickness in an area from D10 to D100. Accordingly, the cutting edge 11 may have a relatively gentle slope in an area from D40 to D100, and the cutting edge 11 may have a relatively steep slope in an area from D100 to D150.

On the other hand, considering the relationship between the thickness, the durability, and the cutting force in each area of the cutting edge 11, a slope of the substrate 10 in each section of the substrate tip 12 in the substrate 10 according to the embodiment of the present disclosure may have a value in a range shown in Table 4 below.

TABLE 4

| Section | Slope |
|---|---|
| D0 to D10 | 0.159 to 0.183 |
| D10 to D100 | 0.062 to 0.087 |
| D4 to D10 | 0.10 to 0.19 |
| D10 to D40 | 0.06 to 0.10 |
| D40 to D100 | 0.05 to 0.10 |
| D100 to D250 | 0.05 to 0.15 |

Referring to Table 4, a slope of the substrate 10 may be 0.159 to 0.183 in a section from the substrate tip 12 to D10 that is 10 micrometers away from the substrate tip 12, and the slope of the substrate 10 may be 0.062 to 0.087 in a section from D10 that is 10 micrometers away from the substrate tip 12 to D100 that is 100 micrometers away from the substrate tip 12.

Since the shaving blade according to an embodiment of the present disclosure has a relatively large thickness in the area from the substrate tip 12 to D10, the cutting edge 11 may have a relatively steep slope in the area from the substrate tip 12 to D10.

Furthermore, since the shaving blade according to an embodiment of the present disclosure has a relatively small thickness in the area from D10 to D100, the cutting edge 11 may have a relatively gentle slope in the area from D10 to D100.

The slope of the substrate 10 may be 0.10 to 0.19 in a section from D4 that is 4 micrometers away from the substrate tip 12 to D10 that is 10 micrometers away from the substrate tip 12.

The slope of the substrate 10 may be 0.06 to 0.10 in a section from D10 that is 10 micrometers away from the substrate tip 12 to D40 that is 40 micrometers away from the substrate tip 12.

The slope of the substrate 10 may be 0.05 to 0.10 in a section from D40 40 micrometers away from the substrate tip 12 to D100 that is 100 micrometers away from the substrate tip 12.

The slope of the substrate 10 may be 0.05 to 0.15 in a section from D100 that is 100 micrometers away from the substrate tip 12 to D250 that is 250 micrometers away from the substrate tip 12.

Meanwhile, a slope of the substrate 10 in a section from D40 to D100 has a smaller value overall than a slope of the substrate 10 in a section from D100 to D250. This means that the substrate 10 has a steeper slope overall in the section from D100 to D250 than in the section from D40 to D100. Accordingly, the cutting edge 11 may have a substantially concave shape in an area around D100.

TABLE 5

| | | | | | | | | | Edge indent |
|---|---|---|---|---|---|---|---|---|---|
| | | | | | | | | | force |
| | | | | | | | | Cutting | resistance |
| | T4 | T10 | T16 | T40 | T64 | T100 | T150 | force | at T10 |
| Example 1 | 1.79 | 3.18 | 4.48 | 7.45 | 11.70 | 15.28 | 24.15 | 4.70 | 20.07 |
| Example 2 | 1.68 | 3.66 | 4.54 | 7.80 | 10.80 | 14.52 | 21.05 | 4.90 | 22.43 |
| Example 3 | 1.84 | 3.34 | 4.70 | 8.12 | 11.02 | 14.82 | 20.50 | 4.75 | 20.85 |
| Example 4 | 1.85 | 3.25 | 4.65 | 8.75 | 12.50 | 18.85 | 24.25 | 4.80 | 20.65 |

In Table 5, values of the thickness, cutting force, and edge indent force resistance at T10 in various examples of the shaving blade according to the embodiment of the present disclosure are presented.

Specifically, Examples 1 and 2 are examples having values of T10 corresponding to the lower and upper limits of T10 in Table 3, and Examples 3 and 4 are examples having values of T100 corresponding to the lower and upper limits of T100 in Table 3.

Furthermore, in Examples 1 to 4, the thickness in each area of the cutting edge 11 falls within the range of the thickness in each area of the cutting edge 11 shown in Table 3.

In Table 5, the unit of the thickness of the cutting edge is and the unit of the cutting force and the edge indent force resistance is gf.

Referring to Table 5, Examples 1 to 4 may have a cutting force of less than 5.0 gf, and may have an edge indent force resistance of 20 gf or more at T10. These values are values that satisfy a range of preferable cutting force and a range of preferable edge indent force resistance described above. That is, Examples 1 to 4 of the shaving blade according to the embodiment of the present disclosure may have sufficient durability and may simultaneously have a sufficiently small cutting force.

Meanwhile, Examples 1 to 4 are examples having thicknesses corresponding to the upper and lower limits of T10 and upper and lower limits of T100 of the shaving blade according to the embodiment of the present disclosure. Accordingly, the shaving blade according to the embodiment of the present disclosure may generally have a preferable cutting force of 5.0 gf or less and a preferable edge indent force resistance of 20 gf or more for embodiments satisfying the thickness ranges of Table 3.

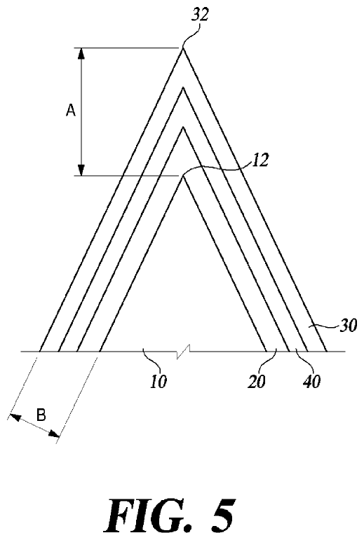

FIG. 5 illustrates a schematic profile of the cutting edge 11 of the substrate 10 on which a plurality of coating layers are stacked according to an embodiment of the present disclosure.

Referring to FIG. 5, the shaving blade may include a plurality of coating layers stacked on the substrate 10.

The plurality of coating layers may include a first coating layer 20, a second coating layer 30, and a third coating layer 40; the first coating layer 20, the third coating layer 40, and the second coating layer 30 may be sequentially stacked on the substrate 10 in this order.

The first coating layer 20 may be stacked on a surface of the substrate 10 to be able to supplement the rigidity of the substrate 10.

The first coating layer 20 may include at least one of chromium boride (CrB), chromium carbide (CrC), and diamond-like carbon (DLC). However, the present disclosure is not limited thereto.

A thickness of the first coating layer 20 may have a value between 150 nanometers and 300 nanometers.

When the first coating layer 20 has a thickness of 150 nanometers or less, the durability of the entire shaving blade may depend on a movement of the substrate 10. In this case, there may be a problem in that the substrate 10 is excessively damaged.

On the other hand, when the first coating layer 20 has a thickness of 300 nanometers or more, the durability of the entire shaving blade may depend on a movement of the first coating layer 20. In this case, a problem in that the cutting force of the shaving blade increases and the first coating layer 20 is peeled off from the surface of the substrate 10 may occur.

The second coating layer 30 may be stacked on the third coating layer 40. However, the present disclosure is not limited thereto. For example, the shaving blade may not include the third coating layer 40, and in this case, the second coating layer 30 may be directly stacked on the first coating layer 20.

The second coating layer 30 may reduce friction force between the shaving blade and the skin.

The second coating layer 30 may include polytetrafluoroethylene (PTFE). However, the present disclosure is not limited thereto.

The second coating layer 30 may include a blade tip 32 formed at a position corresponding to the substrate tip 12.

A value obtained by dividing a distance A between the substrate tip 12 and the blade tip 32 by a vertical height B from one surface of the cutting edge to a surface of the second coating layer 30 may be a value between 1.92 and 2.00.

The plurality of coating layers are stacked on the substrate 10 according to such a ratio, so that the durability of the shaving blade can be further appropriately reinforced.

However, the present disclosure is not limited thereto, and the value obtained by dividing A by B may be a value outside the above-described range depending on an angle, deposition conditions, and physical properties of the substrate 10.

The third coating layer 40 may be stacked on the first coating layer 20 between the first coating layer 20 and the second coating layer 30, and can increase adhesion strength between the first coating layer 20 and the second coating layer 30.

The third coating layer 40 may include a material containing Cr that has excellent adhesion strength. For example, the third coating layer 40 may include at least one of CrB and CrC. However, the present disclosure is not limited thereto.

A thickness of the third coating layer 40 may have a value between 5 nanometers and 30 nanometers.

When the third coating layer 40 has a thickness of 5 nanometers or less, the third coating layer 40 may only form a nucleus and may not form a layer.

On the other hand, when the third coating layer 40 has a thickness of 30 nanometers or more, a problem in that the cutting force of the shaving blade increases may occur.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

### CROSS-REFERENCE TO RELATED APPLICATION

This application claims priority to Patent Application No. 10-2020-0073111, filed on Jun. 16, 2020 in Korea, the entire contents of which are incorporated herein by reference.

### REFERENCE NUMERALS

10: substrate, 11: cutting edge, 12: substrate tip, 20: first coating layer, 30: second coating layer, 32: blade tip, 40: third coating layer

What is claimed is:

1. A shaving blade comprising:
a substrate including a cutting edge at which a sharp substrate tip is formed,
wherein the substrate has
a thickness T10 measured at a distance D10 that is 10 micrometers away from the substrate tip, the thickness T10 having a value between 3.18 micrometers and 3.66 micrometers, and
a thickness T100 measured at a distance D100 that is 100 micrometers away from the substrate tip, the thickness T100 having a value between 14.82 micrometers and 18.85 micrometers.

2. The shaving blade of claim 1, wherein the substrate has a thickness T40 measured at a distance D40 that is 40 micrometers away from the substrate tip, the thickness T40 having a value between 7.20 micrometers and 8.89 micrometers.

3. The shaving blade of claim 1, wherein the substrate has a thickness T8 measured at a distance D8 that is 8 micrometers away from the substrate tip, the thickness T8 having a value between 2.80 micrometers and 3.30 micrometers.

4. The shaving blade of claim 1, wherein the substrate has a thickness T150 measured at a distance D150 that is 150 micrometers away from the substrate tip, the thickness T150 having a value between 20.05 micrometers and 26.25 micrometers.

5. The shaving blade of claim 1, wherein in the substrate, R8, obtained by dividing a thickness T8 measured at a distance D8 that is 8 micrometers away from the substrate tip by D8, has a value equal to or greater than R10, obtained by dividing the thickness T10 measured at the distance D10 that is 10 micrometers away from the substrate tip by D10.

6. The shaving blade of claim 1, wherein in the substrate, R100, obtained by dividing the thickness T100 measured at the distance D100 that is 100 micrometers away from the substrate tip by D100, has a value equal to or less than R10, obtained by dividing the thickness T10 measured at the distance D10 that is 10 micrometers away from the substrate tip by D10.

7. The shaving blade of claim 1, wherein in the substrate, a difference between the thickness T10 measured at the distance D10 that is 10 micrometers away from the substrate tip and a thickness T8 measured at a distance D8 that is 8 micrometers away from the substrate tip has a value of 0.86 micrometers or less.

8. The shaving blade of claim 1, wherein in the substrate, a difference between the thickness T100 measured at the distance D100 that is 100 micrometers away from the substrate tip and a thickness T40 measured at a distance D40 that is 40 micrometers away from the substrate tip has a value of 11.65 micrometers or less.

9. The shaving blade of claim 1, wherein in the substrate, a difference between a thickness T150 measured at a distance D150 that is 150 micrometers away from the substrate tip and the thickness T100 measured at the distance D100 that is 100 micrometers away from the substrate tip has a value of 11.43 micrometers or more.

10. The shaving blade of claim 1,
wherein a slope of the substrate is 0.159 to 0.183 in a section from the substrate tip to D10 that is 10 micrometers away from the substrate tip, and
the slope of the substrate is 0.062 to 0.087 in a section from D10 that is 10 micrometers away from the substrate tip to D100 that is 100 micrometers away from the substrate tip.

11. The shaving blade of claim 1, wherein a slope of the substrate is 0.10 to 0.19 in a section from D4 that is 4 micrometers away from the substrate tip to D10 that is 10 micrometers away from the substrate tip.

12. The shaving blade of claim 1, wherein a slope of the substrate is 0.06 to 0.10 in a section from D10 that is 10 micrometers away from the substrate tip to D40 that is 40 micrometers away from the substrate tip.

13. The shaving blade of claim 1, wherein a slope of the substrate is 0.05 to 0.10 in a section from D40 that is 40 micrometers away from the substrate tip to D100 that is 100 micrometers away from the substrate tip.

14. The shaving blade of claim 1, wherein a slope of the substrate is 0.05 to 0.15 in a section from D100 that is 100 micrometers away from the substrate tip to D250 that is 250 micrometers away from the substrate tip.
